(19) United States
(12) Patent Application Publication
(10) Pub. No.: US 2025/0276476 A1
(43) Pub. Date: Sep. 4, 2025

(54) INJECTION MOLDING MACHINE

(71) Applicant: SUMITOMO HEAVY INDUSTRIES, LTD., Tokyo (JP)

(72) Inventors: Koji KAWANO, Chiba (JP); Shigeru TAKEUCHI, Chiba (JP); Tatsuya YOKOYAMA, Chiba (JP)

(21) Appl. No.: 19/055,748

(22) Filed: Feb. 18, 2025

(30) Foreign Application Priority Data
Feb. 29, 2024 (JP) 2024-030425

(51) Int. Cl. B29C 45/17; B29C 45/04; B29C 45/66; B29C 45/76

(52) U.S. Cl. CPC B29C 45/1753; B29C 45/0416; B29C 45/66; B29C 45/76; B29C 2945/76568; B29C 2945/76735; B29C 2945/76859; B29C 2945/76869

(57) ABSTRACT

An injection molding machine includes: a mold clamping device including: a movable platen having a movable mold and a fixed platen having a fixed mold; and a toggle mechanism that moves the movable platen such that a mold device opens and closes, and disposes the movable platen in a mold clamping position; an injection device that injects molding material into cavity space between the movable mold in the mold clamping position and the fixed mold; and a control device that controls the mold clamping and injection devices. A cleaning process is performed, while the movable platen is at a burr-forming position and farther away from the fixed mold than at the mold clamping position, and the injection device injects the molding material into the mold device to mold an article with burrs. A toggle factor at the burr-forming position is a magnification factor of 1 or greater.

### CROSS-REFERENCE TO RELATED APPLICATION

This application claims priority to Japanese Patent Application No. 2024-030425, filed on Feb. 29, 2024, the entire contents of which are incorporated herein by reference.

### BACKGROUND

### 1. Technical Field

The present disclosure relates to an injection molding machine.

### 2. Description of Related Art

In the technical field of injection molding machines, there is a technology whereby, using a hydraulic actuator, a distance between molds (a movable mold and a fixed mold) in a mold device is adjusted by inserting and removing a member for increasing the distance between the molds.

### SUMMARY

According to one example of the present disclosure, an injection molding machine is provided. This injection molding machine includes:
a mold clamping device including:
a movable platen having a movable mold;
a fixed platen having a fixed mold that faces the movable mold; and
a toggle mechanism configured to move the movable platen in directions in which the mold device opens and closes, relative to the fixed platen, and dispose the movable platen in a mold clamping position;
an injection device configured to inject a molding material into a cavity space formed between the movable mold disposed in the mold clamping position and the fixed mold; and
a control device configured to control operation of the injection device and the mold clamping device, and, in this injection molding machine:
the control device is configured to perform a cleaning process, in which, while the movable platen is moved to a burr-forming position where the movable mold is farther away from the fixed mold than at the mold clamping position, the injection device injects the molding material into the mold device to mold an article with burrs; and
the toggle mechanism is configured such that a toggle factor at the burr-forming position is a magnification factor of 1 or greater.

According to the above example of the present disclosure, burrs can be formed with a simple structure, so that the boundaries between the molds can be cleaned up efficiently.

### BRIEF DESCRIPTION OF THE DRAWINGS

FIG. 1 is a diagram that shows the state of an injection molding machine according to one embodiment of the present disclosure upon completion of mold opening;

FIG. 2 is a diagram that shows the state of the injection molding machine according to one embodiment of the present disclosure upon mold clamping;

FIG. 3 is a functional block diagram that shows examples of components in a control device;

FIG. 4A is a diagram that shows examples of steps in a molding cycle in injection molding;

FIG. 4B is a diagram that shows examples of steps in the molding cycle in a cleaning process;

FIG. 5A is a diagram that shows the state of a mold clamping device for injection molding;

FIG. 5B shows mold thickness adjustment before the cleaning process;

FIG. 5C shows a burr-forming position after a mold closing step in the cleaning process compared to a mold clamping position in injection molding;

FIG. 6 shows an enlarged view of a part of a toggle mechanism;

FIG. 7 is a first flowchart that shows how to perform the cleaning process; and

FIG. 8 is a second flowchart that shows how to perform the cleaning process.

### DETAILED DESCRIPTION

When a distance is formed between molds as in the related art described above, the injection molding machine can deliberately form burrs between the molds by injection molding, and suck and remove the debris (resin mold deposits, gas adhesions, tar, etc.) that are produced at the boundaries between the molds.

If an injection molding machine is structured such that a distance-widening member such as the one mentioned above is provided in the mold device, inconveniences such as increased manufacturing costs, layout restrictions, and structural complications arise. In particular, if a distance-widening member is provided in the mold device every time the mold device is replaced, the cost is likely to increase significantly.

The present disclosure therefore aims to provide an injection molding machine that can form burrs with a simple structure, so that the boundaries between molds can be cleaned up efficiently.

Hereinafter, an embodiment of the present disclosure will be described with reference to the accompanying drawings. In the drawings, the same or corresponding components will be assigned the same or corresponding reference numerals, and the description thereof may be omitted.

### (Injection Molding Machine)

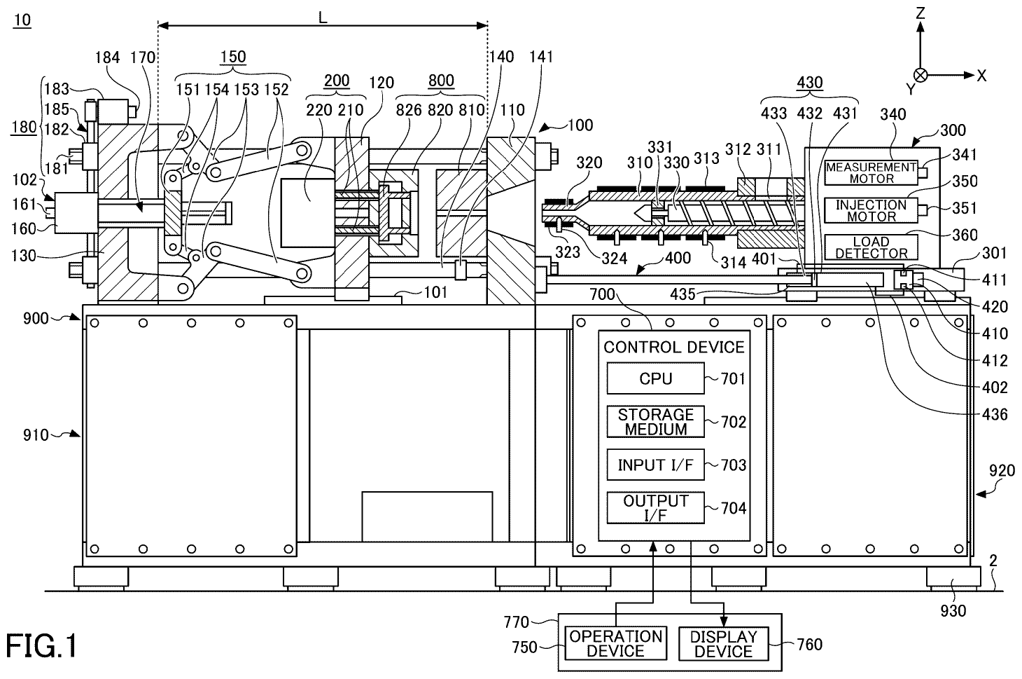

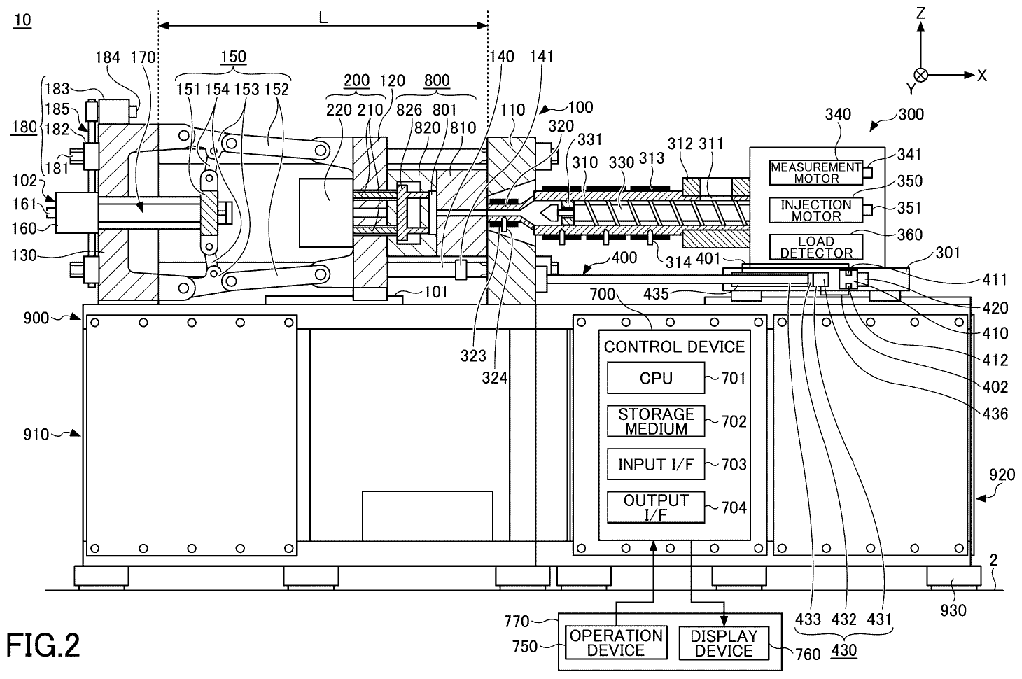

FIG. 1 is a diagram that shows the state of an injection molding machine according to one embodiment of the present disclosure at the time of completion of mold opening. FIG. 2 is a diagram that shows the state of the injection molding machine according to the embodiment of the present disclosure at the time of mold clamping. In the present specification, the X-axis, Y-axis, and Z-axis directions are perpendicular to each other. The X-axis and Y-axis directions are horizontal directions, and the Z-axis direction is a vertical direction. In the event a mold clamping device 100 is a horizontal type, the X-axis direction is the mold opening/closing directions, and the Y-axis direction is the width direction of an injection molding machine 10. The negative side in the Y-axis direction will be hereinafter referred to as an “operation side,” and the positive side in the Y-axis direction will be hereinafter referred to as a “side opposite to the operation side.”

As illustrated in FIG. 1 and FIG. 2, the injection molding machine 10 includes: a mold clamping device 100 that opens and closes a mold device 800; an ejector device 200 that ejects a molded article that is molded by the mold device 800; an injection device 300 that injects a molding material into the mold device 800; a moving device 400 that allows the injection device 300 to move forward and backward (advance and retract) with respect to the mold device 800; a control device 700 that controls components of the injection molding machine 10; and a frame 900 that supports components of the injection molding machine 10. The frame 900 includes a mold clamping device frame 910 that supports the mold clamping device 100 and an injection device frame 920 that supports the injection device 300. The mold clamping device frame 910 and the injection device frame 920 are installed on a floor 2 via leveling adjusters 930. The control device 700 is provided in the internal space of the injection device frame 920. Now, each component of the injection molding machine 10 will be described below.

### (Mold Clamping Device)

In the following description of the mold clamping device 100, the direction in which a movable platen 120 moves at the time of mold closing (for example, the positive X-axis direction) is defined as toward the front, and the direction in which the movable platen 120 moves at the time of mold opening (for example, the negative X-axis direction) is defined as toward the rear.

The mold clamping device 100 performs mold closing, pressure increasing, mold clamping, pressure releasing, and mold opening, for the mold device 800. The mold device 800 includes a fixed mold 810 and a movable mold 820.

The mold clamping device 100 is, for example, a horizontal type, and the molds open and close in horizontal directions. The mold clamping device 100 includes: a fixed platen 110 to which the fixed mold 810 is attached; a movable platen 120 to which the movable mold 820 is attached; and a moving mechanism 102 that allows the movable platen 120 to move, with respect to the fixed platen 110, in directions in which the molds open and close (hereinafter “mold opening/closing directions”).

The fixed platen 110 is fixed to the mold clamping device frame 910. The fixed mold 810 is attached to the surface of the fixed platen 110 facing the movable platen 120.

The movable platen 120 is disposed so as to be movable in mold opening/closing directions with respect to the mold clamping device frame 910. A guide 101 for guiding the movable platen 120 is provided on the mold clamping device frame 910. The movable mold 820 is attached to the surface of the movable platen 120 facing the fixed platen 110.

The moving mechanism 102 moves the movable platen 120 forward and backward with respect to the fixed platen 110 to perform mold closing, pressure increasing, mold clamping, pressure releasing, and mold opening for the mold device 800. The moving mechanism 102 includes: a toggle support 130 disposed at a distance from the fixed platen 110; tie bars 140 that connect the fixed platen 110 and the toggle support 130; a toggle mechanism 150 configured to allow the movable platen 120 to move in mold opening/closing directions with respect to the toggle support 130; a mold clamping motor 160 configured to operate the toggle mechanism 150; a motion conversion mechanism 170 configured to convert rotational motion of the mold clamping motor 160 into linear motion; and a mold thickness adjustment mechanism 180 configured to adjust the interval between the fixed platen 110 and the toggle support 130.

The toggle support 130 is disposed at a distance from the fixed platen 110 and placed on the mold clamping device frame 910 so as to be movable in mold opening/closing directions. The toggle support 130 may be disposed so as to be movable along a guide that is provided on the mold clamping device frame 910. The guide 101 for the movable platen 120 may also serve as the guide for the toggle support 130 as well.

In the present embodiment, although the fixed platen 110 is fixed to the mold clamping device frame 910 and the toggle support 130 is disposed so as to be movable in mold opening/closing directions with respect to the mold clamping device frame 910, it is also possible to employ a structure in which the toggle support 130 is fixed to the mold clamping device frame 910 and the fixed platen 110 is disposed so as to be movable in mold opening/closing directions with respect to the mold clamping device frame 910.

Each tie bar 140 connects the fixed platen 110 and the toggle support 130 with an interval L therebetween in mold opening/closing directions. Multiple (for example, four) tie bars 140 may be used. Multiple tie bars 140 may be arranged in parallel in mold opening/closing directions and extend in accordance with mold clamping force. At least one tie bar 140 may be provided with a tie bar strain detector 141 for detecting the strain of the tie bar 140. The tie bar strain detector 141 sends signals representing detection results obtained thereat to the control device 700. The detection results of the tie bar strain detector 141 is used, for example, to detect the mold clamping force or the like.

In the present embodiment, the tie bar strain detector 141 is used as a mold clamping force detector for detecting the mold clamping force, but the present disclosure is by no means limited to this. The mold clamping force detector is by no means limited to a strain gauge type, and may be a piezoelectric type, a capacitance type, a hydraulic type, an electromagnetic type, or the like, and the position where the mold clamping force detector is attached is by no means limited to the tie bar 140 either.

The toggle mechanism 150 is disposed between the movable platen 120 and the toggle support 130, and allows the movable platen 120 to move in mold opening/closing directions with respect to the toggle support 130. The structure of this toggle mechanism 150 will be described later in detail.

The mold clamping motor 160 is attached to the toggle support 130 and operates the toggle mechanism 150. The mold clamping motor 160 moves the crosshead 151 forward and backward with respect to the toggle support 130, so that a first link 152 and a second link 153 bend and extend, and the movable platen 120 moves forward and backward with respect to the toggle support 130. The mold clamping motor 160 is directly connected to the motion conversion mechanism 170, but may be connected to the motion conversion mechanism 170 via a belt, a pulley, or the like.

The motion conversion mechanism 170 converts the rotational motion of the mold clamping motor 160 into linear motion of the crosshead 151. The motion conversion mechanism 170 includes a screw shaft and screw nuts that mesh with the screw shaft. Balls or rollers may be interposed between the screw shaft and the screw nuts.

The mold clamping device 100 performs a mold closing step, a pressure increasing step, a mold clamping step, a pressure releasing step, a mold opening step, and the like, under the control of the control device 700.

In the mold closing step, the mold clamping motor 160 is driven to advance the crosshead 151 to a position where the molds are completely closed (hereinafter “mold closing completion position”) at a set moving speed, thereby allowing the movable platen 120 to move forward and the movable mold 820 to touch the fixed mold 810. The position and the moving speed of the crosshead 151 are detected by using, for example, a mold clamping motor encoder 161. The mold clamping motor encoder 161 detects the rotation of the mold clamping motor 160 and sends a signal representing the detection result to the control device 700.

The crosshead position detector for detecting the position of the crosshead 151 and the crosshead moving speed detector for detecting the moving speed of the crosshead 151 are by no means limited to the mold clamping motor encoder 161, and general detectors can be used. The movable platen position detector for detecting the position of the movable platen 120 and the movable platen moving speed detector for detecting the moving speed of the movable platen 120 are by no means limited to the mold clamping motor encoder 161, and general detectors can be used.

In the pressure increasing step, a mold clamping force is generated by further driving the mold clamping motor 160 to allow the crosshead 151 to advance from the mold closing completion position to a mold clamping position.

In the mold clamping step, the mold clamping motor 160 is driven so that the position of the crosshead 151 is maintained at the mold clamping position. In the mold clamping step, the mold clamping force generated in the pressure increasing step is maintained. In the mold clamping step, a cavity space 801 (see FIG. 2) is formed between the movable mold 820 and the fixed mold 810, and the injection device 300 fills the cavity space 801 with a liquid molding material. The filled molding material is solidified, and a molded article is obtained.

There may be more than one cavity space 801. In this case, a number of molded articles can be obtained at the same time. An insert component may be disposed in a part of the cavity space 801, and the molding material may fill another part of the cavity spaces 801. By doing so, a molded article in which the insert component and the molding material are integrated is obtained.

In the pressure releasing step, the movable platen 120 is retracted by driving the mold clamping motor 160 to move the crosshead 151 back from the mold clamping position to the position where the mold starts opening (hereinafter “mold opening start position”), and the mold clamping force is reduced. The mold opening start position and the mold closing completion position may be the same position.

In the mold opening step, the movable platen 120 is retracted by driving the mold clamping motor 160 to move the crosshead 151 back from the mold opening start position to the mold opening completion position at a set moving speed, and the movable mold 820 is separated from the fixed mold 810. Subsequently, the ejector device 200 ejects the molded article from the movable mold 820.

The setting conditions for the mold closing step, the pressure increasing step, and the mold clamping step are set collectively as a series of setting conditions. For example, the moving speed and positions of the crosshead 151 (including the mold closing start position, the moving speed switching position, the mold closing completion position, and the mold clamping position) in the mold closing step and the pressure increasing step, and the mold clamping force are set collectively as a series of setting conditions. The mold closing start position, the moving speed switching position, the mold closing completion position, and the mold clamping position are arranged in this order from the rear to the front, and represent, for example, the start point and end point of each section in which the moving speed is set. The moving speed is set in each section. The number of moving speed switching positions may be one or more. It is equally possible not to set a moving speed switching position. Only one of the mold clamping position and the mold clamping force need be set.

The setting conditions for the pressure releasing step and the mold opening step are set in the same manner. For example, the moving speed and position of the crosshead 151 (including the mold opening start position, the moving speed switching position, and the mold opening completion position) in the pressure releasing step and the mold opening step are set collectively as a series of setting conditions. The mold opening start position, the moving speed switching position, and the mold opening completion position are arranged in this order from the front to the rear, and represent, for example, the start point and end point of each section in which the moving speed is set. The moving speed is set in each section. The number of moving speed switching positions may be one or more. It is equally possible not to set a moving speed switching position. The mold opening start position and the mold closing completion position may be the same position. The mold opening completion position and the mold closing start position may be the same position.

Instead of the moving speed and positions of the crosshead 151, the moving speed and positions of the movable platen 120 may be set. Instead of setting the crosshead's position (for example, the mold clamping position) or setting the movable platen's position, the mold clamping force may be set.

In the event the thickness of the mold device 800 changes when, for example, the mold device 800 is replaced, the temperature of the mold device 800 changes, and so on, the mold's thickness is adjusted such that a predetermined mold clamping force is obtained at the time of mold clamping. In the mold thickness adjustment, for example, the interval L between the fixed platen 110 and the toggle support 130 is adjusted such that the link angle θ of the toggle mechanism 150 becomes a predetermined angle at the time the movable mold 820 touches the fixed mold 810 (or at the time of “mold touch”).

The mold clamping device 100 includes a mold thickness adjustment mechanism 180. The mold thickness adjustment mechanism 180 adjusts the mold's thickness by adjusting the interval L between the fixed platen 110 and the toggle support 130. The mold thickness adjustment is performed, for example, at a timing between the end of one molding cycle and the start of the next molding cycle. The mold thickness adjustment mechanism 180 includes, for example, a screw shaft 181 formed at a rear end portion of each tie bar 140, a screw nut 182 held by the toggle support 130 so as to be rotatable yet not movable forward and backward, and a mold thickness adjustment motor 183 that rotates the screw nut 182 screwed to the screw shaft 181.

The screw shaft 181 and the screw nut 182 are provided for each tie bar 140. The rotational driving force of the mold thickness adjustment motor 183 may be transmitted to a number of screw nuts 182 via a rotational driving force transmission part 185. Multiple screw nuts 182 can be rotated synchronously. It is also possible to make multiple screw nuts 182 rotate individually by changing the transmission path from the rotational driving force transmission part 185.

The rotational driving force transmission part 185 is configured by, for example, gears. In this case, a driven gear is formed on the outer periphery of each screw nut 182. A driving gear is attached to the output shaft of the mold thickness adjustment motor 183, and an intermediate gear that meshes with multiple driven gears and the driving gear is rotatably held at the center of the toggle support 130. The rotational driving force transmission part 185 may be configured by belts, pulleys, or the like, instead of gears.

The operation of the mold thickness adjustment mechanism 180 is controlled by the control device 700. The control device 700 drives the mold thickness adjustment motor 183 to rotate the screw nuts 182. As a result of this, the position of the toggle support 130 with respect to the tie bar 140 is adjusted, and the interval L between the fixed platen 110 and the toggle support 130 is adjusted. Multiple mold thickness adjustment mechanisms may be used in combination.

The interval L is detected by using the mold thickness adjustment motor encoder 184. The mold thickness adjustment motor encoder 184 detects the amount of rotation and the direction of rotation of the mold thickness adjustment motor 183 and sends a signal representing the detection result to the control device 700. The detection result of the mold thickness adjustment motor encoder 184 is used to monitor and control the position of the toggle support 130, the interval L, and so forth. The toggle support position detector for detecting the position of the toggle support 130 and the interval detector for detecting the interval L are by no means limited to the mold thickness adjustment motor encoder 184, and general detectors can be used as well.

The mold clamping device 100 may include a mold temperature adjuster that controls the temperature of the mold device 800. The mold device 800 has a flow path for a temperature adjusting medium. The mold temperature adjuster adjusts the temperature of the mold device 800 by adjusting the temperature of the temperature adjusting medium supplied to the flow path in the mold device 800.

The mold clamping device 100 of the present embodiment is a horizontal type, in which the mold opens and closes horizontally, but may be a vertical type in which the mold opens and closes vertically.

The mold clamping device 100 of the present embodiment includes the mold clamping motor 160 as a drive part but may include a hydraulic cylinder instead of the mold clamping motor 160. Also, the mold clamping device 100 may include a linear motor for opening and closing the mold and an electromagnet for clamping the mold.

### (Ejector Device)

In the following description of the ejector device 200, similarly to the description of the mold clamping device 100, the direction in which the movable platen 120 moves at the time of mold closing (for example, the positive X-axis direction) is defined as toward the front, and the direction in which the movable platen 120 moves at the time of mold opening (for example, the negative X-axis direction) is defined as toward the rear.

The ejector device 200 is attached to the movable platen 120 and moves forward and backward together with the movable platen 120. The ejector device 200 includes ejector rods 210 that eject the molded article from the mold device 800, and a drive mechanism 220 that moves the ejector rods 210 in directions in which the movable platen 120 moves (the positive and negative X-axis directions).

Each ejector rod 210 is disposed in a through-hole of the movable platen 120 so as to be movable forward and backward. The front end portion of each ejector rod 210 is in contact with an ejector plate 826 of the movable mold 820. The front end portion of each ejector rod 210 may be connected with the ejector plate 826 or need not be connected with the ejector plate 826.

The drive mechanism 220 includes, for example, an ejector motor and a motion conversion mechanism that converts the rotational motion of the ejector motor into linear motion of the ejector rods 210. The motion conversion mechanism include a screw shaft and screw nuts that mesh with the screw shaft. Balls or rollers may be interposed between the screw shaft and the screw nuts.

The ejector device 200 performs the ejection process under the control of the control device 700. In the ejection step, the ejector rods 210 are moved forward from the standby positions to the ejection positions at a set moving speed, allowing the ejector plate 826 to move forward and eject the molded article. Subsequently, the ejector motor is driven to retract the ejector rods 210 at a set moving speed, and the ejector plate 826 is retracted to resume its original standby position.

The position and moving speed of the ejector rods 210 are detected by using, for example, an ejector motor encoder. The ejector motor encoder detects the rotation of the ejector motor and sends a signal representing the detection result to the control device 700. The ejector rod position detector for detecting the positions of the ejector rods 210 and the ejector rod moving speed detector for detecting the moving speed of the ejector rods 210 are by no means limited to an ejector motor encoder, and general detectors can be used as well.

### (Injection Device)

In the following description of the injection device 300, unlike the description of the mold clamping device 100 and the description of the ejector device 200, the direction in which the screw 330 moves at the time of filling (for example, the negative X-axis direction) is defined as toward the front, and the direction in which the screw 330 moves at the time of measuring (for example, the positive X-axis direction) is defined as toward the rear.

The injection device 300 is installed on a slide base 301, and the slide base 301 is disposed so as to be movable forward and backward with respect to an injection device frame 920. The injection device 300 is disposed so as to be movable forward and backward with respect to the mold device 800. The injection device 300 touches the mold device 800 and fills the cavity space 801 inside the mold device 800 with the molding material. The injection device 300 includes, for example, a cylinder 310 that heats the molding material, a nozzle 320 provided at a front end portion of the cylinder 310, a screw 330 disposed in the cylinder 310 so as to be movable forward and backward and rotatable, a measuring motor 340 that rotates the screw 330, an injection motor 350 that moves the screw 330 forward and backward, and a load detector 360 that detects the load transmitted between the injection motor 350 and the screw 330.

The cylinder 310 heats the molding material supplied from a supply port 311 to the inside. The molding material includes, for example, a resin. The molding material is formed in a pellet shape, for example, and is supplied to the supply port 311 in a solid state. The supply port 311 is formed in a rear portion of the cylinder 310. A cooler 312, such as a water-cooled cylinder or the like, is provided on the outer periphery of the rear portion of the cylinder 310. A first heater 313, such as a band heater or the like, and a first temperature detector 314 are provided on the outer periphery of the cylinder 310 in front of the cooler 312.

The cylinder 310 is divided into a number of zones in the axial direction (for example, the X-axis direction) of the cylinder 310. The first heater 313 and the first temperature detector 314 are provided for each zone. A set temperature is set for each zone, and the control device 700 controls the first heater 313 such that the temperature detected by the first temperature detector 314 reaches the set temperature.

The nozzle 320 is provided at a front end portion of the cylinder 310 and is pressed against the mold device 800. A second heater 323 and a second temperature detector 324 are provided on the outer periphery of the nozzle 320. The control device 700 controls the second heater 323 such that the temperature detected by the nozzle 320 reaches the set temperature.

The screw 330 is disposed in the cylinder 310 so as to be rotatable and movable forward and backward. When the screw 330 is rotated, the molding material is pushed forward along the spiral groove of the screw 330. The molding material is pushed forward and gradually melted by the heat from the cylinder 310. The liquid molding material is pushed to the front of the screw 330 and accumulated in a front portion of the cylinder 310, and the screw 330 is retracted. Subsequently, when the screw 330 is advanced, the liquid molding material accumulated in front of the screw 330 is injected from the nozzle 320 and fills the mold device 800.

A backflow prevention ring 331 is attached to a front portion of the screw 330 so as to be movable forward and backward. The backflow prevention ring 331 serves as a backflow prevention valve that prevents backflow of the molding material from the front to the rear of the screw 330 when the screw 330 is pushed forward.

When the screw 330 is advanced, the backflow prevention ring 331 is pushed backward by the pressure of the molding material in front of the screw 330 and retracted, relative to the screw 330, to a closure position (see FIG. 2) at which the backflow prevention ring 331 blocks the flow path of the molding material. This prevents the molding material accumulated in front of the screw 330 from flowing backward.

On the other hand, when the screw 330 is rotated, the backflow prevention ring 331 is pushed forward by the pressure of the molding material pushed forward along the spiral groove of the screw 330 and moves forward, relative to the screw 330, to a release position (see FIG. 1) at which the backflow prevention ring 331 opens the flow path of the molding material. Thus, the molding material is pushed to the front of the screw 330.

The backflow prevention ring 331 may be either a co-rotation type that rotates together with the screw 330 or a non-co-rotation type that does not rotate with the screw 330.

The injection device 300 may include a drive source that moves the backflow prevention ring 331 forward and backward between the release position and the closure position with respect to the screw 330.

The measuring motor 340 rotates the screw 330. The drive source for rotating the screw 330 is by no means limited to the measuring motor 340, and may be, for example, a hydraulic pump.

The injection motor 350 moves the screw 330 forward and backward. Between the injection motor 350 and the screw 330, a motion conversion mechanism or the like for converting the rotational motion of the injection motor 350 into linear motion of the screw 330 is provided. The motion conversion mechanism includes, for example, a screw shaft and screw nuts that mesh with the screw shaft. Balls, rollers, or the like may be provided between the screw shaft and the screw nuts. The drive source for advancing and retracting the screw 330 is by no means limited to the injection motor 350, and may be, for example, a hydraulic cylinder.

The load detector 360 detects the load transmitted between the injection motor 350 and the screw 330. The detected load is converted into a pressure by the control device 700. The load detector 360 is provided in a load transmission path between the injection motor 350 and the screw 330, and detects the load that acts on the load detector 360.

The load detector 360 sends a signal representing the detected load to the control device 700. The load that is detected by the load detector 360 is converted into a pressure that acts between the screw 330 and the molding material, and is used to control or monitor the pressure that the screw 330 receives from the molding material, the back pressure upon the screw 330, the pressure that acts on the molding material from the screw 330, and the like.

The pressure detector for detecting the pressure of the molding material is by no means limited to the load detector 360, and a general pressure detector can be used. For example, a nozzle pressure sensor or a mold internal pressure sensor may be used. A nozzle pressure sensor may be provided in the nozzle 320. A mold internal pressure sensor may be provided inside the mold device 800.

The injection device 300 performs the measurement step, a filling step, a maintenance step, and the like under the control of the control device 700. The filling step and the maintenance step may be collectively referred to as “injection step.”

In the measurement step, the measuring motor 340 is driven to rotate the screw 330 at a set rotation speed, and the molding material is pushed forward along the spiral groove of the screw 330. As a result of this, the molding material is gradually melted. As the liquid molding material is pushed to the front of the screw 330 and accumulated in a front portion of the cylinder 310, and the screw 330 is retracted. The rotation speed of the screw 330 is detected by using, for example, the measuring motor encoder 341. The measuring motor encoder 341 detects the rotation of the measuring motor 340 and sends a signal representing the detection result to the control device 700. The screw rotational speed detector for detecting the rotational speed of the screw 330 is by no means limited to the measuring motor encoder 341, and a general detector can be used as well.

In the measurement step, in order to prevent or substantially prevent the screw 330 from moving backward suddenly, the injection motor 350 may be driven to apply a predetermined back pressure to the screw 330. The back pressure to the screw 330 is detected by using, for example, the load detector 360. When the screw 330 moves backward to a measuring completion position and a predetermined amount of molding material is accumulated in front of the screw 330, the measurement step is completed.

The positions and rotation speed of the screw 330 in the measurement step are set collectively as a series of setting conditions. For example, a measurement start position, a rotational speed switching position, and a measuring completion position are set. These positions are arranged in this order from the front to the rear, and represent, for example, the start point and the end point of each section in which the rotation speed is set. The rotation speed is set in each section. The number of rotation speed switching positions may be one or more. The rotation speed switching position need not be set. Furthermore, a back pressure is set in each section.

In the filling step, the injection motor 350 is driven to move the screw 330 forward at a set moving speed, and the liquid molding material accumulated in front of the screw 330 is filled in the cavity space 801 in the mold device 800. The position and the moving speed of the screw 330 are detected by using, for example, the injection motor encoder 351. The injection motor encoder 351 detects the rotation of the injection motor 350 and sends a signal representing the detection result to the control device 700. When the position of the screw 330 reaches a set position, the filling step switches to the maintenance step (known as “V/P switchover”). The position where the V/P switchover takes place is also referred to as a “V/P switchover position.” The set moving speed of the screw 330 may be changed according to the position of the screw 330, time, and so forth.

The positions and moving speed of the screw 330 in the filling step are set collectively as a series of setting conditions. For example, a filling start position (also referred to as an “injection start position”), a moving speed switching position, and a V/P switchover position are set. These positions are arranged in this order from the rear to the front, and represent, for example, the start point and the end point of each section in which the rotation speed is set. The moving speed is set in each section. The number of moving speed switching positions may be one or more. It is equally possible not to set a moving speed switching position.

An upper limit value for the pressure of the screw 330 is set in each section in which the moving speed of the screw 330 is set. The pressure of the screw 330 is detected by the load detector 360. In the event the pressure of the screw 330 is lower than or equal to the set pressure, the screw 330 moves forward at the set moving speed. On the other hand, in the event the pressure of the screw 330 exceeds the set pressure, for the purpose of protecting the mold, the screw 330 moves forward at a lower moving speed than the set moving speed so that the pressure of the screw 330 becomes lower than or equal to the set pressure.

Note that, after the position of the screw 330 reaches the V/P switchover position in the filling step, the screw 330 may be temporarily stopped at the V/P switchover position, and then a V/P switchover may take place. Shortly before the V/P switchover, it is also possible to move the screw 330 forward or backward at a very low speed, instead of stopping the screw 330. The screw position detector for detecting the position of the screw 330 and the screw moving speed detector for detecting the moving speed of the screw 330 are by no means limited to the injection motor encoder 351, and general detectors can be used as well.

In the maintenance step, the injection motor 350 is driven to push the screw 330 forward, the pressure of the molding material at a front end portion of the screw 330 (hereinafter also referred to as “maintenance pressure”) is maintained at the set pressure, and the molding material that remains in the cylinder 310 is pushed toward the mold device 800. The molding material that is short due to cooling shrinkage in the mold device 800 can be thus replenished. The maintenance pressure is detected by using, for example, the load detector 360. The set value of the maintenance pressure may be changed according to the length of time elapsed from the start of the maintenance step. Multiple maintenance pressures and multiple durations of time for maintaining the maintenance pressures in the maintenance step may be set, and may be set collectively as a series of setting conditions.

In the maintenance step, the molding material in the cavity space 801 in the mold device 800 is gradually cooled down. When the maintenance step is completed, the inlet of the cavity space 801 is closed by the solidified molding material. This state is referred to as a “gate seal,” and a backflow of the molding material from the cavity space 801 is prevented. After the maintenance step is performed, the cooling step is started. In the cooling step, the molding material in the cavity space 801 is solidified. In order to shorten the molding cycle time, the measurement step may be performed during the cooling step.

The injection device 300 of the present embodiment is an in-line screw type, but may be a pre-plasticization type or the like. A pre-plasticizing injection device supplies the molding material melted in a plasticizing cylinder to an injection cylinder, and injects the molding material from the injection cylinder into the mold device. In the plasticizing cylinder, a screw that is able to rotate and unable to move forward and backward may be disposed, or a screw that is able to rotate and move forward and backward may be disposed. On the other hand, a plunger is disposed in the injection cylinder so as to be movable forward and backward.

The injection device 300 of the present embodiment is a horizontal type in which the axial direction of the cylinder 310 is horizontal, but may be a vertical type in which the axial direction of the cylinder 310 is vertical. A vertical or horizontal mold clamping device may be combined with a vertical injection device 300. Similarly, a vertical or horizontal mold clamping device may be combined with a horizontal injection device 300.

### (Moving Device)

In the following description of the moving device 400, similarly to the description of the injection device 300, the direction in which the screw 330 moves at the time of filling (for example, the negative X-axis direction) is defined as toward the front, and the direction in which the screw 330 moves at the time of measuring (for example, the positive X-axis direction) is defined as toward the rear.

The moving device 400 advances and retracts the injection device 300 with respect to the mold device 800. The moving device 400 presses the nozzle 320 against the mold device 800 to generate a nozzle touch pressure. The moving device 400 includes a hydraulic pump 410, a motor 420 that serves as a drive source, a hydraulic cylinder 430 that serves as a hydraulic actuator, and so forth.

The hydraulic pump 410 has a first port 411 and a second port 412. The hydraulic pump 410 is a pump that can rotate in both directions, and generates a hydraulic pressure by switching the rotation direction of the motor 420 and sucking in the working liquid (for example, oil) from one of the first port 411 and the second port 412 and discharging the liquid from the other port. The hydraulic pump 410 can also suck in the working liquid from a tank and discharge the working liquid from one of the first port 411 and the second port 412.

The motor 420 operates the hydraulic pump 410. The motor 420 drives the hydraulic pump 410 in a rotational direction and with a rotational torque corresponding to a control signal from the control device 700. The motor 420 may be an electric motor or an electric servo motor.

The hydraulic cylinder 430 includes a cylinder main body 431, a piston 432, and a piston rod 433. The cylinder main body 431 is fixed to the injection device 300. The piston 432 divides the inside of the cylinder main body 431 into a front chamber 435, which serves as a first chamber, and a rear chamber 436, which serves as a second chamber. The piston rod 433 is fixed to the fixed platen 110.

The front chamber 435 of the hydraulic cylinder 430 is connected to the first port 411 of the hydraulic pump 410 via a first flow path 401. The working liquid discharged from the first port 411 is supplied to the front chamber 435 via the first flow path 401, so that the injection device 300 is pushed forward. The injection device 300 is advanced, and the nozzle 320 is pressed against the fixed mold 810. The front chamber 435 functions as a pressure chamber that generates a nozzle touch pressure for the nozzle 320 by the pressure of the working liquid supplied from the hydraulic pump 410.

The rear chamber 436 of the hydraulic cylinder 430 is connected to the second port 412 of the hydraulic pump 410 via a second flow path 402. The working liquid discharged from the second port 412 is supplied to the rear chamber 436 of the hydraulic cylinder 430 via the second flow path 402, so that the injection device 300 is pushed backward. The injection device 300 is retracted, and the nozzle 320 is separated from the fixed mold 810.

In the present embodiment, the moving device 400 includes the hydraulic cylinder 430, but the present disclosure is by no means limited to this example. For example, instead of the hydraulic cylinder 430, an electric motor and a motion conversion mechanism that converts the rotational motion of the electric motor into linear motion of the injection device 300 may be used.

### (Control Device)

The control device 700 is configured by, for example, a computer, and includes a central processing unit (CPU) 701, a storage medium 702 such as a memory, an input interface 703, and an output interface 704 as illustrated in FIG. 1 and FIG. 2. The control device 700 performs various controls by causing the CPU 701 to execute programs stored in the storage medium 702. The control device 700 receives a signal from an external device through the input interface 703, and transmits a signal to the external device through the output interface 704.

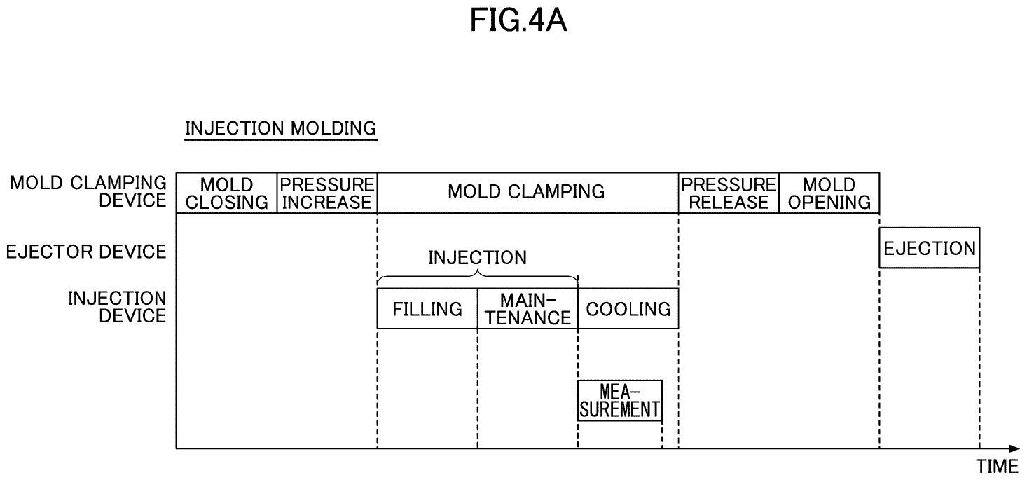

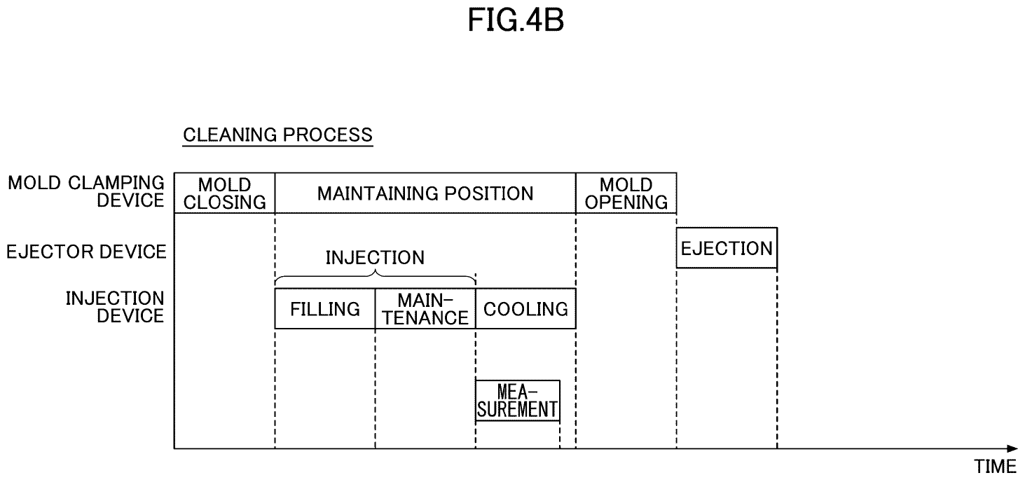

The control device 700 repeats performing the measurement step, the mold closing step, the pressure increasing step, the mold clamping step, the filling step, the maintenance step, the cooling step, the pressure releasing step, the mold opening step, the ejection step, and the like, thereby manufacturing molded articles on a continuous basis (see FIG. 4). A series of operations for obtaining a molded article, for example, the operation from the start of the measurement step to the start of the next measurement step is also referred to as a “shot” or a “molding cycle.” The time required for one shot is referred to as “molding cycle time” or “cycle time.”

One molding cycle includes, for example, a measurement step, a mold closing step, a pressure increasing step, a mold clamping step, a filling step, a maintenance step, a cooling step, a pressure releasing step, a mold opening step, and an ejection step in this order. The order here is the order of in which each step starts. The filling step, the maintenance step, and the cooling step are performed during the mold clamping step. The start of the mold clamping step may match the start of the filling step. The completion of the pressure releasing step match the start of the mold opening step.

In order to shorten the molding cycle time, multiple steps may be performed at the same time. For example, the measurement step may be performed during the cooling step of the previous molding cycle, or may be performed during the mold clamping step. In this case, the mold closing step may be performed at the beginning of the molding cycle. The filling step may be started during the mold closing step. The ejection step may be started during the mold opening step. In the event an opening/closing valve that opens and closes the flow path of the nozzle 320 is provided, the mold opening step may be started during the measurement step. This is because even if the mold opening step is started during the measurement step, the molding material does not leak from the nozzle 320 as long as the opening/closing valve closes the flow path of the nozzle 320.

One molding cycle may include steps other than the measurement step, the mold closing step, the pressure increasing step, the mold clamping step, the filling step, the maintenance step, the cooling step, the pressure releasing step, the mold opening step, and the ejection step.

For example, after the maintenance step is completed, before the measurement step is started, a pre-measurement suck-back step of retracting the screw 330 to a predetermined measurement start position may be performed. This reduces the pressure of the molding material accumulated in front of the screw 330 before the measurement step is started, thereby preventing the screw 330 from retracting suddenly when the measurement step is started.

After the measurement step is completed, before the filling step is started, a post-measuring suck-back step may be performed to retract the screw 330 to a preset filling start position (also referred to as “injection start position”). This reduces the pressure of the molding material accumulated in front of the screw 330 before the filling step is started, and a leakage of the molding material from the nozzle 320 before the filling step is started can be prevented.

The control device 700 is connected with an operation device 750 which receives operational inputs from the user, and with a display device 760, on which a screen is displayed. The operation device 750 and the display device 760 may be configured by, for example, a touch panel 770, and may be integrated together. The touch panel 770, which serves as the display device 760, displays a screen under the control of the control device 700. For example, information, such as the settings of the injection molding machine 10 and the current state of the injection molding machine 10, may be displayed on the screen of the touch panel 770. On the screen of the touch panel 770, an operation part, such as buttons or an input field for receiving operational inputs from the user, may be displayed. The touch panel 770, which serves as the operation device 750, detects operational inputs from the user on the screen, and outputs signals corresponding to the operational inputs to the control device 700. Thus, for example, the user can perform setting (including inputting setting values) of the injection molding machine 10 by operating the operation part provided on the screen while checking information displayed on the screen. The user operates the operation part provided on the screen, and the operation of the injection molding machine 10 is thus controlled according to operations made on the operation part. The operation of the injection molding machine 10 may refer to, for example, the operation (including stopping) of the mold clamping device 100, the ejector device 200, the injection device 300, the moving device 400, and so forth. The operation of the injection molding machine 10 may refer to switching of the screen displayed on the touch panel 770 as the display device 760.

Note that the operation device 750 and the display device 760 of the present embodiment have been described as being integrated together as the touch panel 770, but may be provided separately. Also, multiple operation devices 750 may be provided. The operation device 750 and the display device 760 are disposed on the operation side (negative Y-axis direction) of the mold clamping device 100 (more specifically, the fixed platen 110).

### (Details of Control Device)

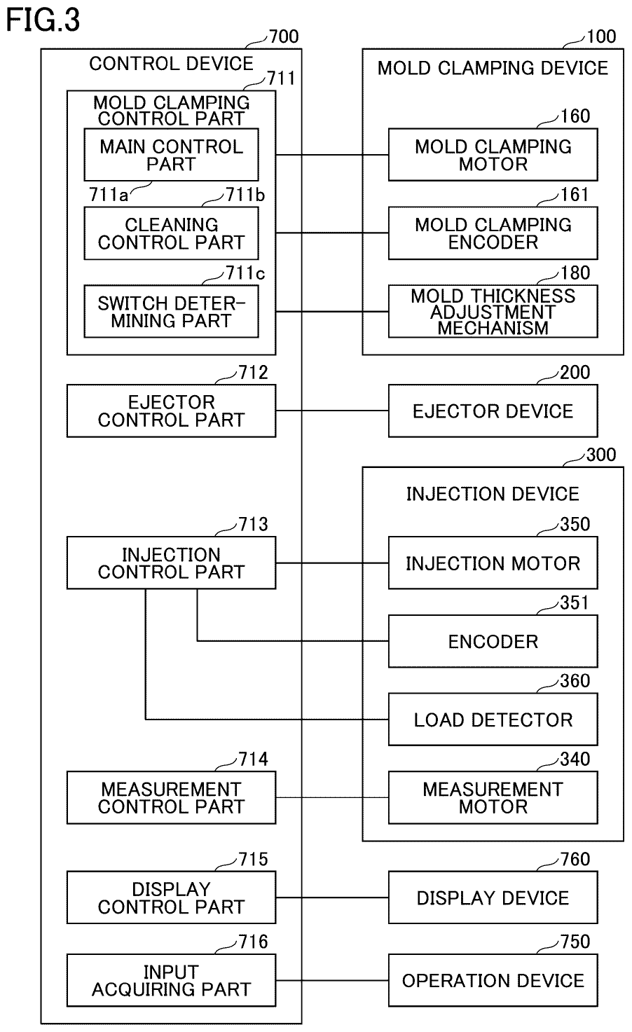

Next, examples of the components of the control device 700 will be described with reference to FIG. 3. Note that the functional blocks illustrated in FIG. 3 are conceptual and do not necessarily have to be provided physically as illustrated in FIG. 3. Some or all of the functional blocks may be functionally or physically distributed or integrated together in any units as desired. All or any part of the processing functions performed by the functional blocks may be implemented by programs executed by the CPU or may be implemented as hardware by wired logic.

As shown in FIG. 3, the control device 700 includes, for example, a mold clamping control part 711, an ejector control part 712, an injection control part 713, a measurement control part 714, a display control part 715, and an input acquiring part 716. The mold clamping control part 711 controls the mold clamping device 100, and performs the mold closing step, pressure increasing step, mold clamping step, pressure releasing step, and mold opening step as shown in FIG. 4. The ejector control part 712 controls the ejector device 200 and performs the ejection step. The injection control part 713 controls the injection drive source of the injection device 300 and performs the injection step. The injection drive source is, for example, the injection motor 350, but may also be a hydraulic cylinder or the like. The injection step includes a filling step and a maintenance step. The injection step is performed during the mold clamping step. The measurement control part 714 controls the measuring drive source of the injection device 300 and carries out the measurement step. The measuring drive source is, for example, a measuring motor 340, but may also be a hydraulic pump or the like. The measurement step is performed during the cooling step.

The filling step is a process of controlling the injection drive source such that the actual value of the moving speed of an injection member provided inside the cylinder 310 becomes the set value. The filling step is a process of filling the inside of the mold device 800 with the liquid molding material (for example, resin) accumulated in front of the injection member by moving the injection member forward. The injection member is, for example, the screw 330, but may also be a plunger.

The moving speed of the injection member is detected using a speed detector. The speed detector is, for example, the injection motor encoder 351. In the filling step, the pressure that acts on the molding material from the injection member increases as the injection member moves forward. The filling step may include, shortly before the maintenance step, a step of temporarily stopping the injection member or a step of retracting the injection member.

The maintenance step is a process of controlling the injection drive source such that the actual value of the pressure that acts on the molding material from the injection member becomes a set value. The maintenance step is a process of pushing the injection member forward to replenish the molding material that is short due to cooling contraction in the mold device 800. The pressure is detected using a pressure detector such as the load detector 360. As for the pressure detector, a nozzle pressure sensor or a mold internal pressure sensor may be used.

Also, the display control part 715 of the control device 700 transmits display screen information related to injection molding, for example, before injection molding is started, in each step during injection molding, and after injection molding is completed, and controls the display device 760 to display each piece of information. Multiple display screens are prepared, so that the display control part 715 allows multiple screens to be switched between and displayed, laid over one another and displayed, and so forth.

Furthermore, the input acquiring part 716 of the control device 700 acquires information about the details of operations the user performs on the operation device 750, based on the display screen displayed on the display device 760. For example, when the settings of the injection molding are changed by the user, the input acquiring part 716 stores the settings in the storage medium 702.

### (Cleaning Process)

In the injection molding machine 10, during injection molding, debris (resin mold deposits, gas adhesions, tar, etc.) are sometimes produced at the boundaries between the fixed mold 810 and the movable mold 820 of the mold device 800. With conventional injection molding machines, a worker performs cleaning to remove such debris by, for example, wiping the boundaries between the molds with a cloth soaked in a cleaning agent such as alcohol. This cleaning is performed when injection molding is repeated a set number of times, or when the work period of injection molding exceeds a set period of time. For example, cleaning is performed approximately once a day. This cleaning causes inconveniences such as an increased burden of the worker and a decrease in the productivity of molded articles.

Therefore, the injection molding machine 10 according to the embodiment is structured to deliberately mold an article with burrs leaked between the fixed mold 810 and the movable mold 820, and the cleaning process is performed to suck the debris at the boundaries between the molds (the fixed mold 810 and the movable mold 820). The injection molding machine 10, for example, automatically performs the cleaning process after performing injection molding a set number of times, and removes the debris at the boundaries between the molds. By this means, the injection molding machine 10 reduces the number of times the worker performs cleaning, thus making it possible to reduce the burden of the worker, and improve the productivity of molded articles.

In addition, the injection molding machine 10 may be structured to perform the cleaning process only once between one injection molding and another injection molding, or may be structured to perform the cleaning process multiple times between one injection molding and another injection molding. For example, the injection molding machine 10 may be structured to change the number of times to perform the cleaning process in conjunction with, for example, the number of times normal injection molding is performed. Also, for example, the injection molding machine 10 may be structured to perform the cleaning process at the end of an operation in which injection molding is repeated continuously.

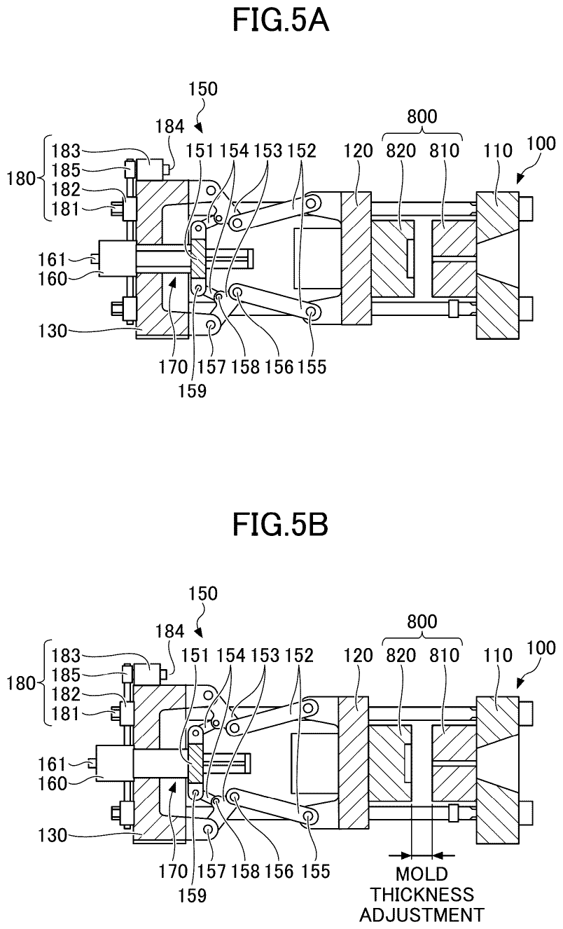

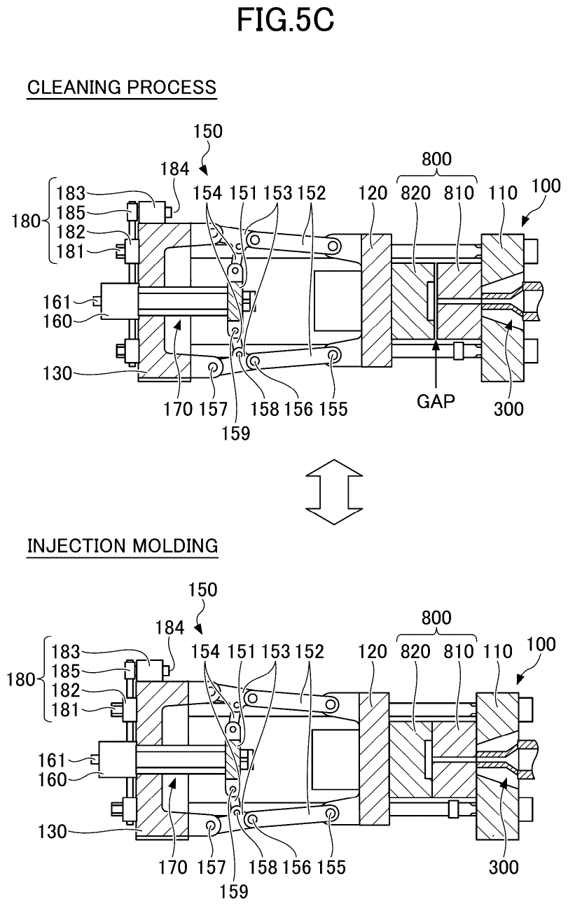

As shown in FIG. 5A to FIG. 5C, during the cleaning process, the injection molding machine 10 controls the fixed mold 810 and the movable mold 820 to separate from each other and form a gap therebetween such that burrs are formed at the boundaries between the molds. For example, the control device 700 operates the mold thickness adjustment mechanism 180 to adjust (make longer) the interval L between the fixed platen 110 and the toggle support 130, thereby setting the interval between the fixed platen 110 and the movable platen 120 in injection molding to the interval for the cleaning process. As a consequence of this mold thickness adjustment, when the injection molding machine 10 performs the mold closing step, it becomes possible to dispose the movable mold 820 at a burr-forming position, where the movable mold 820 is separated from the fixed mold 810 further than at the mold clamping position in normal injection molding.

The upper diagram of FIG. 5C shows the burr-forming position when the molds are closed during the cleaning process, and the lower diagram in FIG. 5C shows, for comparison, the mold clamping position when the molds are clamped in normal injection molding. The burr-forming position is located on the negative X-axis direction side with respect to the mold clamping position. For example, depending on the molding material's fluidity or the like, the burr-forming position may be set at a gap that is formed between the boundaries of the molds and is approximately 0.5 mm to 2 mm. This burr-forming position may be set in advance by performing experiments or simulations, and stored in the control device 700 with the interval for the cleaning process. Alternatively, the burr-forming position may be set in any desired way based on operations that the worker performs on the operation device 750.

In addition, in the cleaning process, the injection molding machine 10 may execute control such that the mold clamping force is reduced, while maintaining mold touch (contact) is maintained, without completely separating the fixed mold 810 and the movable mold 820. In other words, the burr-forming position may be set as close as possible to the mold clamping position. However, employing a structure that reduces the mold clamping force may result in a situation in which the force that the toggle mechanism 150 can withstand varies depending on the amount by which the movable mold 820 opens from the fixed mold 810. Therefore, depending on the pressure from the molding material, the movable platen 120 need not be stopped at the desired position. It is therefore more preferable if the injection molding machine 10 performs the cleaning process by controlling the mold clamping force to zero by setting the burr-forming position such that a gap is formed between the fixed mold 810 and the movable mold 820.

If the movable mold 820 is moved to the burr-forming position and then the injection device 300 injects the molding material into the mold device 800, the molding material leaks from the cavity space 801 into the boundaries between the molds. The leaked molding material sucks debris and turns into burrs when cooled down. Therefore, by deliberately molding an article with burrs, the injection molding machine 10 makes it possible to remove the debris from the boundaries between the fixed mold 810 and the movable mold 820.

However, during the cleaning process, the injection molding machine 10 must not move (retract) the movable mold 820 that is disposed in the burr-forming position, in the negative X-axis direction. Assuming that the toggle mechanism 150 is bent significantly in the burr-forming position, if the molding material is injected in the mold device 800 in this state, it is predictable that the burr-forming position cannot be maintained and a significant amount of burrs will be produced. In this case, the injection molding machine 10 will be unable to remove the molded article with burrs from the movable mold 820. Consequently, by adjusting the thickness of the molds using the mold thickness adjustment mechanism 180, the injection molding machine 10 according to embodiment provides an area in which the thrust of the crosshead 151 (which is, for example, a force by ball screws and a motor, a force by a linear actuator such as a hydraulic cylinder, etc.) is amplified by the toggle mechanism 150.

The area in which the thrust of the crosshead 151 is amplified by the toggle mechanism 150 is where the toggle factor is 1/1 or greater. In other words, in the injection molding machine 10, the mold thickness adjustment mechanism 180 adjusts the molds' thickness such that the toggle factor of the toggle mechanism 150 is 1/1 or greater at the burr-forming position. The toggle mechanism 150 keeps the toggle factor less than 1/1 in the majority of the molds' opening/closing stroke. Depending on the design of the toggle mechanism 150, the area in which the amplification by the toggle mechanism 150 applies (that is, the range in which the toggle factor is 1/1 or greater) is approximately 10% of the mold opening/closing stroke.

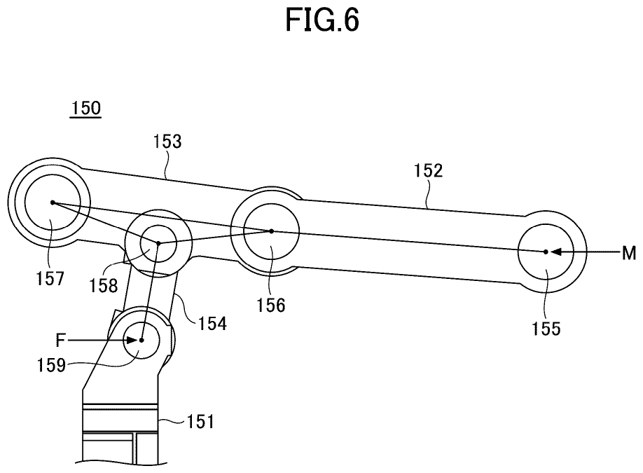

However, it is more preferable if the toggle mechanism 150 makes the toggle factor 5 times to 10 times larger. By making the toggle factor 5 times to 10 times larger or more, it then becomes possible to more reliably prevent misplacement of the movable platen 120 and the movable mold 820 during the cleaning process. Next, the toggle factor of the toggle mechanism 150 will be explained with reference to FIG. 6.

As shown in FIG. 6, the toggle mechanism 150 has a crosshead 151 that moves in mold opening/closing directions, and a pair of link groups that bend and expand following the movement of the crosshead 151. Each link group includes a first link 152, a second link 153, and a third link 154. One end of the first link 152 is swingably attached to the movable platen 120 by a first pin 155. One end of the second link 153 is swingably attached to the other end of the first link 152 by a second pin 156. Also, the other end of the second link 153 is swingably attached to the toggle support 130 by a third pin 157. One end of the third link 154 is swingably attached to the inside of the second link 153, at an intermediate position, by a fourth pin 158. The other end of the third link 154 is swingably attached to a protruding part formed on an outer surface of the crosshead 151 by a fifth pin 159.

Given the link groups structured in this manner, by making the crosshead 151 advance in the positive X-axis direction, the third link 154 moves the intermediate position of the second link 153 in the opening direction. One end of the second link 153 moves in the positive X-axis direction, so that the connecting point with the first link 152 (second pin 156) extends, pushing the first link 152 in the positive X-axis direction. Consequently, following this advancement of the first link 152, the movable platen 120 advances in the positive X-axis direction. On the other hand, when the crosshead 151 is retracted in the negative X-axis direction, the link group moves the movable platen 120 in the negative X-axis direction, resulting in the reverse of the above operation.

The toggle mechanism 150 amplifies the driving force of the mold clamping motor 160 and transmits it to the movable platen 120. The amplification factor through the toggle mechanism 150 is also referred to as “toggle factor.” The toggle factor α can be calculated by the following mathematical expression 1:

$$M = α \cdot F \\ Toggle factor α = M / F \qquad ( Mathematical Expression 1 )$$

In the mathematical expression 1, the toggle factor α corresponds to the coefficient part of F, which is the force from the crosshead 151. M is the force obtained by multiplying the force F of the crosshead 151 by the toggle factor α, and can be applied to the movable platen 120. In other words, if the toggle factor α is 1/1 or greater, a force M that is greater than or equal to the force F of the crosshead 151 is applied to the movable platen 120. Here, the force M, obtained by multiplying the force F from the crosshead 151 by the toggle factor α, can be measured using a detector such as a strain sensor. Also, the toggle factor α can be changed by changing the arrangement of the pins 156 to 159 and changing the intersecting angle of the line segments connecting the pins.

As described above, the toggle mechanism 150 can amplify the driving force of the mold clamping motor 160 according to the toggle factor α, and transmit it from the crosshead 151 to the movable platen 120. If the toggle factor α is 1/1 or greater, the toggle mechanism 150 can obtain a fixing force that prevents the movable platen 120 and the fixed mold from retracting, even when the injection device 300 injects the molding material into the mold device 800. That is, the mold clamping device 100 using the toggle mechanism 150 can easily eliminate the inconvenience of the movable platen 120 opening due to its inability to withstand the pressure when the mold device 10 is filled with the molding material. In particular, the mold thickness adjustment by the mold thickness adjustment mechanism 180 provides an advantage of allowing the injection molding machine 10 to be used at positions where the toggle factor α is high. Although the toggle factor α is increased at burr-forming positions, increasing the toggle factor α entails a disadvantage of increasing the load on each component.

Also, when the movable mold 820 is moved away from the fixed mold 810, usually, the toggle factor α decreases, whereas, when the movable mold 820 is brought closer to the fixed mold 810, the toggle factor α increases. If the toggle factor α is set high, for example, at a position where the movable mold 820 is away from the fixed mold 810 and where the toggle factor α is not needed, the toggle factor α may become too high at the mold clamping position, and the mold clamping force may become too high. Consequently, the toggle factor α is set to less than 1 at positions where the movable mold 820 is away from the fixed mold 810.

However, according to this embodiment, the arrangement of the pins 156 to 159 is designed such that the toggle factor α is 1 or greater in burr-forming positions even while the movable mold 820 is away from the fixed mold 810.

The structure of the toggle mechanism 150 is by no means limited to the one shown in FIG. 6. For example, while each link group has five nodes in FIG. 6, each link group may have four nodes instead, or one end of the third link 154 may be connected to the node between the first link 152 and the second link 153.

Referring back to FIG. 3, the control device 700 has a main control part 711a, a cleaning control part 711b, and a switch determining part 711c, inside the mold clamping control part 711, for performing normal injection molding and the cleaning process. The injection molding machine 10 can control the operation of the mold clamping device 100 in normal injection molding and the cleaning process, based on the process that each functional part of the mold clamping control part 711 performs.

To be more specific, the main control part 711a is a functional part for controlling normal injection molding. The main control part 711a controls the operation (the mold closing step, the pressure increasing step, the mold clamping step, the pressure releasing step, the mold opening step, etc.) of the mold clamping device 100 in injection molding (see also FIG. 4A). For example, the main control part 711a controls the mold clamping motor 160 to move the movable platen 120 and the movable mold 820 to the positions set in respective processes (the mold opening/closing start positions, moving speed switching positions, mold closing completion position, mold clamping position, etc.). In addition, the main control part 711a controls the mold clamping motor 160 by using information detected by the mold clamping motor encoder 161 to adjust the position of the movable mold 820.

The cleaning control part 711b is a functional part for controlling the cleaning process. When switching injection molding to the cleaning process, the cleaning control part 711b controls the operation of the mold thickness adjustment mechanism 180 of the mold clamping device 100 to switch the positions of the movable platen 120 and the movable mold 820 to the positions for the cleaning process. The positions for the cleaning process are positions where, during the mold closing step, the movable platen 120 and the movable mold 820 are placed in burr-forming positions, as described earlier.

After this mold thickness adjustment is performed, the cleaning control part 711b controls the operation (the mold closing step, the position maintaining step, the mold closing step, etc.) of the mold clamping device 100 in the cleaning process (see also FIG. 4B). The mold closing step in the cleaning process is a step of moving the movable platen 120 and the movable mold 820 up to burr-forming positions. The position maintaining step in the cleaning process is a step of maintaining the movable mold 820 at the burr-forming position and controlling the injection device 300 to perform the injection step (the filling step and the maintenance step) and the cooling step during this period. The mold opening step in the cleaning process is a step of retracting the movable platen 120 and the movable mold 820 from the burr-forming positions. Note that, to reduce the mold clamping force between the fixed mold 810 and the movable mold 820 while holding these molds in contact with each other during the cleaning process, the cleaning control part 711b may perform the pressure increasing step between the mold closing step and the position maintaining step, and perform the pressure releasing step between the position maintaining step and the mold opening step.

The switch determining part 711c determines whether to switch from normal injection molding to the cleaning process and whether to switch from the cleaning process to normal injection molding. For example, the switch determining part 711c has a threshold for determining whether or not to start the cleaning process, counts the actual number of times injection molding is performed, and determines to start the cleaning process when this actual number reaches or exceeds the threshold. The same applies when returning from the cleaning process to injection molding. Alternatively, the switch determining part 711c may report whether the cleaning process can be performed through the display device 760 or the like, and determine to start the cleaning process following the worker's control.

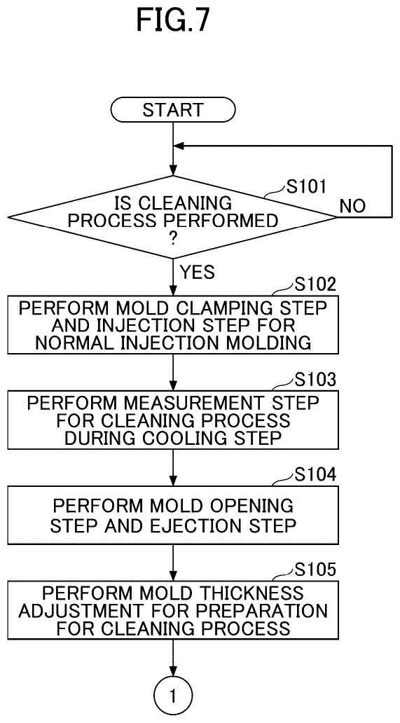

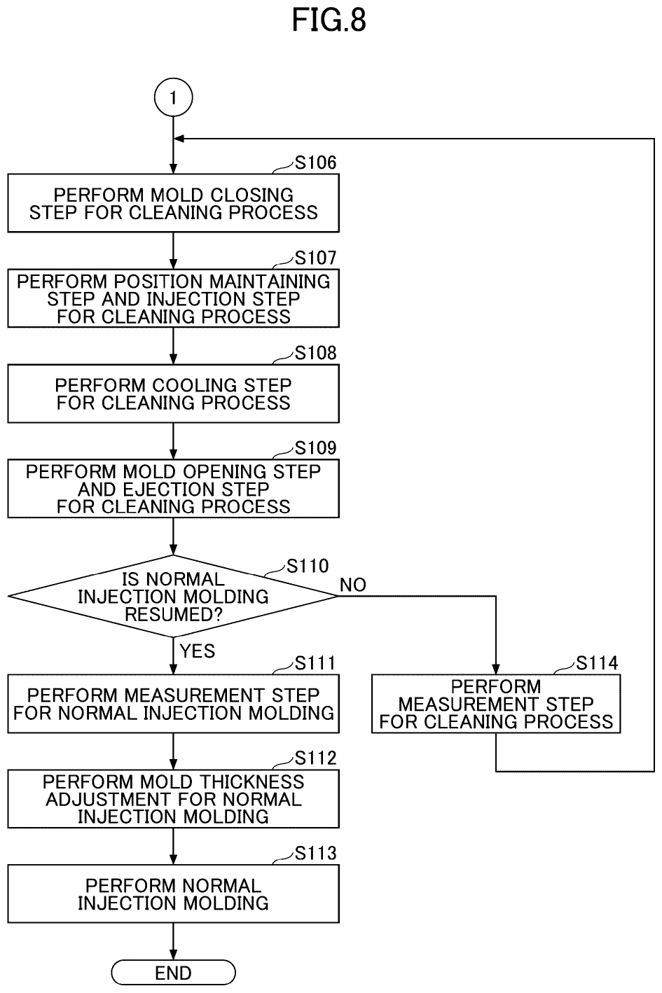

The injection molding machine 10 according to the embodiment is basically structured as described above. Now, an example of the cleaning process will be described below with reference to FIG. 7 and FIG. 8.

The control device 700 of the injection molding machine 10 performs steps S101 to S114 in FIG. 7 and FIG. 8, in order, as an operation method of the cleaning process.

To be more specific, the switch determining part 711c of the control device 700 determines whether or not to perform the cleaning process while the main control part 711a is performing normal injection molding (step S101). For example, the switch determining part 711c increments the actual number of times injection molding is performed at the start of the mold closing step by the mold clamping device 100, compares this value against the starting threshold, and determines whether or not to switch to the cleaning process after injection molding is performed. When the control device 700 determines to perform the cleaning process (step S101: YES), the flow proceeds to step S102, and, when the control device 700 determines not to perform the cleaning process (step S101: NO), step S101 is repeated.

Then, while the control device 700 is performing normal injection molding, the control device 700 prepares for the next cleaning process. To be more specific, in normal injection molding, the control device 700 performs the injection step (the filling step and the maintenance step) by the injection device 300 while performing the pressure increasing step and the mold clamping step by the mold clamping device 100 (step S102).

Then, while the cooling step is being performed after the injection step, the measurement control part 714 of the control device 700 performs a measurement step that suits the following cleaning process, and measures the amount of molding material in this measurement step, envisaging that burrs will be formed (step S103). The amount of molding material taking into account the burrs that will be formed depends, for example, on the shape of the molded article and the molding conditions. For example, the amount of molding material may be adjusted to increase by approximately 1% to 10% compared to the amount of molding material in normal injection molding. Alternatively, the amount of molding material need not be different between normal injection molding and the cleaning process.

After the cooling step is performed, the control device 700 controls the mold clamping device 100 to perform the pressure releasing step and the mold opening step for normal injection molding, and also controls the ejector device 200 to perform the ejection step of ejecting the molded article (step S104). However, after the molded article is ejected, the control device 700 may stop the ejector rods 210 at a midway point, rather than retracting the ejector rods 210 to their return limit. By stopping the ejector rods 210 at a midway point, a gap can be formed in parts that the ejector rods 210 push when the cleaning process is performed, so that the release of the molded article having burrs can be promoted. The parts that the ejector rods 210 may preferably be parts of burrs, for example.

When the ejector device 200 is retracted, the normal injection molding cycle ends. Then, the control device 700 transitions to a molding cycle in which the cleaning process is performed. In this case, the cleaning control part 711b of the control device 700 performs mold thickness adjustment by operating the mold thickness adjustment mechanism 180 such that the movable platen 120 and the movable mold 820 are retracted back to the positions for the cleaning process, as a preparation for the cleaning process (step S105). For example, the cleaning control part 711b operates the mold thickness adjustment mechanism 180 such that the movable mold 820 is spaced 1.5 mm apart from the fixed mold 810 in the mold closing step of the cleaning process.

When the mold thickness adjustment by the mold thickness adjustment mechanism 180 is completed, the cleaning control part 711b executes a molding cycle in which the cleaning process is performed. As shown in FIG. 8, in the cleaning process, the cleaning control part 711b first controls the mold clamping device 100 to move the movable platen 120 and the movable mold 820 in the positive X-axis direction to perform the mold closing step (step S106). By this means, the movable platen 120 and the movable mold 820 are brought close to the fixed mold 810 and disposed in burr-forming positions (see also FIG. 5C). These burr-forming positions are, for example, positions where the boundaries of the fixed mold 810 and the movable mold 820 are spaced apart by a gap of 1.5 mm.

The cleaning control part 711b then controls the mold clamping device 100 to perform the position maintaining step, while the injection control part 713 controls the injection device 300 to perform the injection step (the filling step and the maintenance step) (step S107). In this position maintaining step, the cleaning control part 711b drives the mold clamping motor 160 to maintain the toggle factor α of the toggle mechanism 150 at 1/1 or greater without changing the burr-forming positions. By this means, even if the injection device 300 fills the mold device 800 with the molding material in the injection step, the movable platen 120 and the movable mold 820 can be prevented from being retracted (from being misplaced).

After the injection step is performed, the control device 700 moves on to the cooling step and finishes the molding the article with burrs (step S108). The burrs have debris attached thereto, from the boundaries between the molds.

Furthermore, the control device 700 performs the mold opening step, retracts the movable mold 820 from the fixed mold 810, and controls the ejector device 200 to perform the step of ejecting the molded article (step S109). By this means, the molded article is removed from the movable mold 820, and the debris at the boundaries between the molds are removed. The molded article with burrs is removed and discarded, for example, by an automatic sorting machine or the worker. Note that the worker may perform the task of removing the burrs from the molded articles with burrs.

Also, the switch determining part 711c determines whether or not to resume normal injection molding during the current cleaning process (step S110). For example, the switch determining part 711c monitors whether or not the cleaning process has been performed a set number of times. If the cleaning process has been performed the set number of times, the switch determining part 711c determines to resume injection molding. On the other hand, if the cleaning process has not been performed the set number of times, the switch determining part 711c determines to repeat the cleaning process. Note that in FIG. 8, the decision to resume injection molding is described as being made after the ejection step is performed, but the decision to resume injection molding may be made in parallel with the injection step of the cleaning process, and is preferably made at least before the cooling retraction in the cleaning process. By this means, when the measurement step is performed during the cooling step, the amount of molding material can be measured appropriately in accordance with the next injection molding.

If normal injection molding is to be resumed (step S110: YES), the flow proceeds to step S111, and the molding material for injection molding is measured. Then, after the ejection step is performed, the control device 700 switches to the molding cycle in which the next normal injection molding will be performed. In this case, the main control part 711a of the control device 700 operates the mold thickness adjustment mechanism 180 to advance the movable platen 120 and the movable mold 820 to the positions for injection molding in preparation for normal injection molding (step S112).

After step S112, the injection molding machine 10 resumes normal injection molding (step S113). As a consequence of the preparatory mold thickness adjustment, the movable platen 120 and the movable mold 820 resume their original positions, so that the main control part 711a can operate the mold clamping device 100 can stably perform the mold closing step, pressure increasing step, mold clamping step, pressure releasing step, mold opening step, and so on.

On the other hand, if the cleaning process is to be repeated (step S110: NO), the flow proceeds to step S114 and the molding material for the cleaning process is measured. After the ejection step is performed, the control device 700 returns to step S106 and performs the cleaning process again.

As described earlier, the injection molding machine 10 according to the embodiment employs a simple structure in which the position of the movable mold 820 is adjusted under the control of the control device 700, thereby enabling an article to be molded with burrs and the boundaries between the molds to be cleaned up in an efficient manner. Moreover, the movable platen 120 and the movable mold 820 disposed in burr-forming positions can stably maintain the burr-forming positions because the toggle factor α of the toggle mechanism 150 is 1/1 or greater. This allows the shape (size, etc.) of the burrs to be adjusted appropriately to remove dust. As a result of this, the injection molding machine 10 can reduce the number of times the worker has to clean up the mold device 800, thereby reducing the burden of the worker and improving the overall productivity of molded articles. For example, the injection molding machine 10 can change the number of times the worker does the cleaning of the mold device 800 from once a day to once every several days (for example, once every seven days).

In particular, during the cleaning process, the injection molding machine 10 can stably mold burrs of a set size by forming a gap between the movable mold 820 and the fixed mold 810 that have been moved to burr-forming positions.

Also, before performing the cleaning process, the injection molding machine 10 operates the mold thickness adjustment mechanism 180 to adjust the interval between the fixed platen 110 and the movable platen 120 to an interval for the cleaning process. By this means, the injection molding machine 10 can stably maintain the toggle factor α at a high magnification, even when the movable platen 120 and the movable mold 820 are placed in burr-forming positions during the cleaning process.

Furthermore, after the cleaning process is completed, the injection molding machine 10 can adjust the interval between the fixed platen 110 and the movable platen 120 to an interval for injection molding and resume injection molding, thereby allowing injection molding to be resumed smoothly after the cleaning process is performed.

Also, by repeating the cleaning process multiple times, the injection molding machine 10 can sufficiently remove the debris produced at the boundaries between the fixed mold 810 and the movable mold 820.

Also, the injection molding machine 10 determines the start and/or end of the cleaning process prior to the measurement step of the injection device 300, allowing it to measure an appropriate amount of molding material in the measurement step. By this means, the control device 700 can more smoothly switch between normal injection molding and the cleaning process.

Also, by setting the toggle factor α of the toggle mechanism 150 to 5 times larger or more at burr-forming positions, it is possible to more reliably prevent the movable platen 120 that has been moved to the burr-forming position from being misplaced.

Note that the injection molding machine 10 according to embodiment is by no means limited to the above embodiment and may be provided in an variety of altered ways. For example, the injection molding machine 10 has only to be disposed at a burr-forming position where the toggle factor α is 1/1 or greater, and the method of adjusting the positions of the movable platen 120 and the movable mold 820 is by no means limited to the mold thickness adjustment by the mold thickness adjustment mechanism 180. For example, the injection molding machine 10 may position the movable platen 120 and the movable mold 820 at burr-forming positions by controlling the mold clamping motor 160 without performing mold thickness adjustment. Even in this case, if the toggle factor α is 1/1 or greater, it is still possible to prevent or substantially prevent the movable platen 120 and the movable mold 820 from being retracted.

Also, for example, the injection molding machine 10 may employ a method in which filling of the molding material is started with a wide gap as in compression molding, and, after the filling is done, the movable platen 120 and the movable mold 820 are moved to crush the molded article and form burrs. In this case, even if the movable platen 120 and the movable mold 820 are placed in burr-forming positions, the pressure of the molding material is low, and burrs can be formed while increasing the toggle factor α by moving the movable platen 120.

The injection molding machine 10 according to the embodiment disclosed herein is illustrative in all respects and is not restrictive. The embodiment can be modified and improved in various forms without departing from the scope and spirit of the appended claims. The matters described in the above embodiment can have other structures to the extent that they are not inconsistent, and can also be combined to the extent that they are not inconsistent.

What is claimed is:

1. An injection molding machine comprising:
a mold clamping device including:
a movable platen having a movable mold;
a fixed platen having a fixed mold that faces the movable mold; and
a toggle mechanism configured to move the movable platen in directions in which a mold device opens and closes, relative to the fixed platen, and dispose the movable platen in a mold clamping position;
an injection device configured to inject a molding material into a cavity space formed between the movable mold disposed in the mold clamping position and the fixed mold; and
a control device configured to control operation of the injection device and the mold clamping device,
wherein the control device is configured to perform a cleaning process, in which, while the movable platen is at a burr-forming position where the movable mold is farther away from the fixed mold than at the mold clamping position, the injection device injects the molding material into the mold device to mold an article with burrs, and
wherein the toggle mechanism is configured such that a toggle factor at the burr-forming position is a magnification factor of 1 or greater.

2. The injection molding machine according to claim 1, wherein the control device is configured to form, during the cleaning process, a gap between the movable mold having moved to the burr-forming position, and the fixed mold.

3. The injection molding machine according to claim 2,
wherein the mold clamping device has a mold thickness adjustment mechanism configured to adjust an interval between the fixed platen and the movable platen, and
wherein the control device is configured to operate, before the cleaning process is performed, the mold thickness adjustment mechanism to adjust the interval between the fixed platen and the movable platen to an interval for the cleaning process.

4. The injection molding machine according to claim 3, wherein the control device is configured to adjust the interval between the fixed platen and the movable platen to an interval for injection molding and resumes injection molding after the cleaning process is performed.

5. The injection molding machine according to claim 1, wherein the control device is configured to repeat the cleaning process a plurality of times.

6. The injection molding machine according to claim 5,
wherein the control device is configured to perform a detection of a start of the cleaning process or an end of the cleaning process, or both, before the injection device performs a measurement step, and
wherein the control device is configured to perform the measurement step, the measurement step including measuring an amount of the molding material according to a result of the detection.

7. The injection molding machine according to claim 1, wherein the toggle mechanism is configured such that the toggle factor at the burr-forming position is a magnification factor of 5 or greater.
